(19) United States
(12) Patent Application Publication
(10) Pub. No.: US 2008/0211918 A1
(43) Pub. Date: Sep. 4, 2008

(54) Method and Device for Evaluating the Quality of a Signal

(75) Inventor: Christoph Balz, Muenchen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rohde & Schwarz GmbH & Co. KG, Muenchen (DE)

(21) Appl. No.: 11/629,951

(22) PCT Filed: Apr. 28, 2005
(86) PCT No.: PCT/EP05/04586

§ 371 Date: Dec. 6, 2007

(30) Foreign Application Priority Data
Jun. 18, 2004 (DE) 102004029421.6

(51) Int. Cl. H04N 17/02

(52) U.S. Cl. 348/192

(57) ABSTRACT

A method and device evaluating the quality of a signal by virtue of the deviation of at least one measured characteristic variable of the signal in relation to an associated reference value. The quality is calculated by averaging all of the deviations which are determined and standardized in relation to said characteristic variables.

The invention relates to a method and a device for evaluating the quality of a signal, especially a communications signal.

Transmitters and modulators, for example, in the context of Digital Video Broadcasting-Terrestrial (DVB-T), generate high-complexity-transmission signals, for example, orthogonal frequency division multiplexing signals (OFDM). These high-complexity communications signals are characterised by a plurality of parameters and can be falsified by a plurality of interference factors.

The object of field measurement, for example, in the context of DVB-T, is to register the DVB-T transmission signal in a distortion-free manner at a random position within the DVB-T network, and, using digital measurement-value processing, to determine certain previously-established parameters of the received DVB-T transmission signal with reference to several measurement values of the received DVB-T transmission signal. These parameters characterise the quality of the digital transmission signal and are used by a person skilled in the art of digital-television engineering for the purpose of diagnosis, system or device approval.

In practice, measurement receivers, which receive the DVB-T transmission signal at different times, determine the individual parameters from this signal by means of digital signal processing and compare them with corresponding previously-established reference values, are set up at different positions in the DVB-T network. If each determined parameter is disposed within a certain previously-established tolerance range relative to the reference value, the DVB-T transmission signal can be qualified as correct with regard to the parameter.

A method, wherein a qualification of this kind is implemented for one parameter of the signal, especially with a time-variable reference value, is disclosed in DE 101 63 505 A1.

With a more complex transmission signal, for example, an OFTM-modulated transmission signal, which is characterised by a plurality of parameters and can be falsified by a plurality of interference factors, the complexity of the qualification is considerably increased by comparison with the solution disclosed in DE 101 63 505 A1. A person skilled in the art concerned with diagnosis or certification is therefore very rapidly confronted with a very complex and time-consuming qualification. In the diagnosis and certification process, he will be very quickly lost in considerations of detail and optimisation of details. The effects of these detail optimizations on the overall quality of the digital OFDM transmission signal in this context are very difficult to estimate in qualitative or quantitative terms. A complete overview of the current quality status of the OFDM transmission signal, or the quality status of the OFDM transmission signal previously achieved by optimisation methods, is easily lost in this context.

The invention is therefore based on the object of providing a method and a device, with which the quality of the complex transmission signal can be determined relatively simply and rapidly on the basis of measured parameters of a complex transmission signal.

This object is achieved by a method for determining the quality of a signal according to claim 1 and a device for evaluating the quality of a signal according to claim 14. Advantageous developments of the invention are specified in the dependent claims.

For this purpose, the device according to the invention determines, for each parameter of the transmission signal, the deviation of the measured parameter relative to a previously-established reference value and implements a scaling with the maximum possible deviation of the parameter relative to its respective reference value for each accordingly-determined deviation. Scaling the individual, dimension-bound deviations allows a subsequent, unified mathematical treatment of all the deviations, which become dimensionless as a result of the scaling. The influence of one parameter and its deviation relative to the respective reference value on the quality of the complex transmission signal can be adjusted individually by means of weighting factors. The quality of the complex transmission signal is determined by averaging the weighted and scaled deviations.

The maximum possible deviation of a parameter relative to its reference value is obtained from the maximum deviation of the reference value relative to the upper or lower signal-range limit, both of which are established previously. The deviations are determined by forming the difference between the reference value and the measured parameter—in the case of the maximum deviation, by forming the difference between the reference value and the upper or lower signal-range limit—and subsequent modulus formation. In this manner, it can be guaranteed that positive deviations are provided for the subsequent averaging, even in the event of negative differences or in the case of negative parameters.

If a parameter is measured outside the signal range defined by the previously-established upper and lower signal-range limit, the measured parameter is limited for the evaluation according to the method of the invention to the upper or lower signal-range limit. This means that, as a result of the subsequent scaling of the respective deviation, each scaled deviation comes to be disposed within the scaled range between ±1.

The evaluation of the individually-scaled deviations relative to one another by means of weighted averaging is implemented dependent upon the type of parameter either in a linear, quadratic, logarithmic or exponential manner.

In order to provide a clear overview, the deviation and quality values determined are graphically visualised. For example, colour scales, which characterise the determined value of the deviation or the quality of the signal by a defined colour value, can be used, in this context. If the previously-established signal range is exceeded by the measured parameters, this can be underlined as a warning using a defined colour value, for example, red.

In a first embodiment of the device according to the invention for evaluating the quality of a signal, several test measurement receivers are distributed within the DVB-T network and transmit their received DVB-T transmission signals via standard data-transmission ports to a main computer for further processing. By contrast, in a second embodiment of the device according to the invention for evaluating the quality of the signal, only a single test measurement receiver, which is coupled directly to the main computer, is provided.

The embodiments of the method and the device for determining the quality of a signal are explained in greater detail below with reference to the drawings. The drawings are as follows:

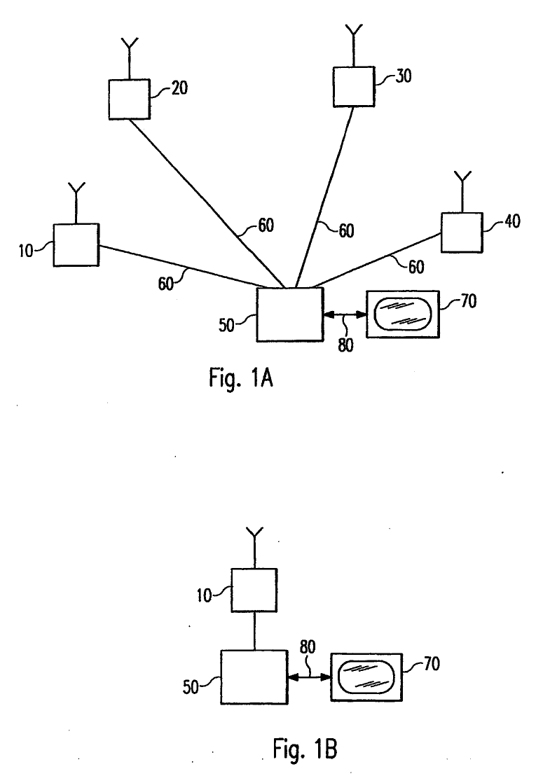

FIGS. 1A, 1B show block circuit diagrams of a first and second embodiment of the device according to the invention for evaluating the quality of a signal;

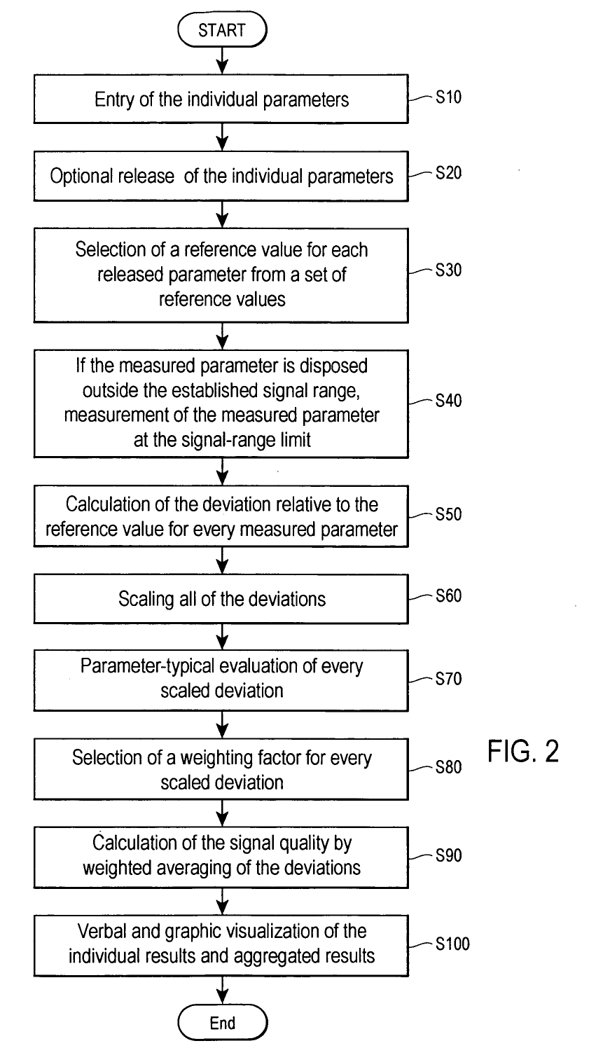

FIG. 2 shows a flow chart of the method according to the invention for determining the quality of a signal;

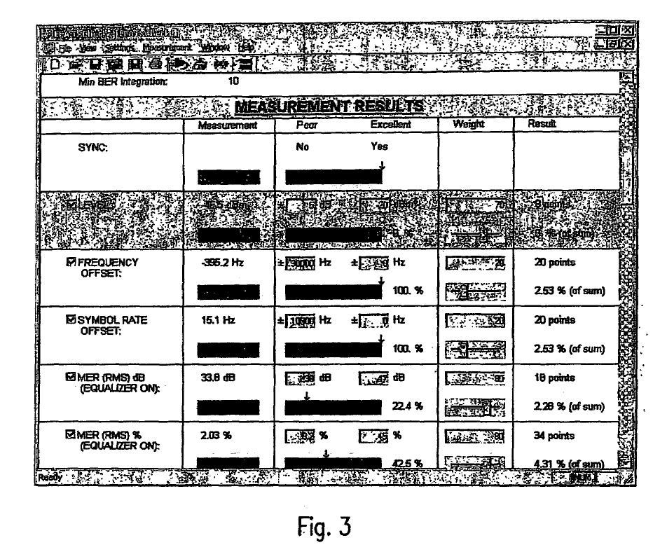

FIG. 3 shows a graphic display of the results (Part 1) determined by the method according to the invention; and

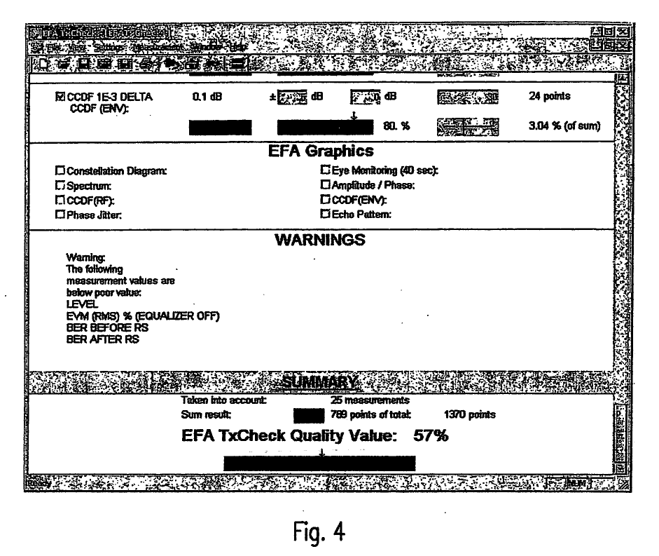

FIG. 4 shows a graphic display of the results (Part 2) determined by the method according to the invention.

The device according to the invention for evaluating the quality of a signal consists, in its first embodiment as shown in FIG. 1A, of several test measurement receivers, 10, 20, 30, 40, for example, the EFA test measurement receiver manufactured by Rohde & Schwarz, which are installed at individual positions within the DVB-T network. Each individual test measurement receiver 10, 20, 30, 40, measures the respective, individual parameters of the DVB-T transmission signal. The measurement values in the individual test measurement receivers 10, 20, 30, 40, are scanned by the main computer 50 via remote control or remote inquiry using standard data-transmission ports 60, for example, RS 232 ports or IEC-bus ports, and processed and visualised according to the method of the invention. The visualisation takes place via a graphic display device 70 connected to the main computer 50 via a visualisation port 80. The user can also use the graphic display device 70 as an input medium for setting the parameters and controlling the overall method of the invention.

The second embodiment of the device according to the invention for evaluating the quality of a signal as shown in FIG. 1B, provides only one test measurement receiver 10, which is coupled directly to the main computer 50 without remote control. In this case, for further processing according to the method of the invention, the main computer 50 has only one record of entered parameters at its disposal. The test measurement receiver 10, the main computer 50 and the display device 70 can also be integrated in a common housing.

In both embodiments, the conventional pre-processing functions for measured data—for example, filtering, averaging, analog/digital conversion etc.—are implemented by the respective test measurement receivers 10, 20, 30, 40 with the registered parameters Xᵢ.

The method according to the invention for evaluating the quality Qₛ of a signal, especially a DVB-T transmission signal, begins according to FIG. 2 with procedural stage S10, in which the parameters Xᵢ previously established for evaluating the quality Qₛ of the signal are entered from the test measurement receiver 10, 20, 30, 40.

In the next procedural stage S20, the user is provided with a control option in the main computer 50 to block or release certain parameters Xᵢ from the maximum number of entered parameters Xₙ for further processing according to the method of the invention. For this purpose, the visualisation interface 80 provides the user with a control field for each established parameter.

In the next procedural stage S30, a reference value X_{Refi} is determined for each established and released parameter Xᵢ. This is obtained, for example, from the specification of the transmission standard, for example, the modulation method used, or with reference to the quality requirements desired by the DVB-T operator. Since these reference values X_{Refi} for each individual parameter Xᵢ of the transmission signal need not necessarily represent fixed values, the user can employ the visualisation interface 80 to select from and if required modify previously-established sets of reference values to obtain the reference value X_{Refi} appropriate for the test measurement of each individual parameter Xᵢ.

In a similar manner to the sets of reference value, the user can select from previously-established records a data pair Xᵤₚᵢ and X_{lowi} for the upper and the lower signal-range limit for each individual parameter Xᵢ in a given test measurement. If the entered and released parameter Xᵢ is disposed outside the signal range, then the parameter Xᵢ is set in procedural stage S40 according to equation (1) to the value of the upper signal-range limit Xᵤₚᵢ, if the parameter Xᵢ is greater than the upper signal-range limit Xᵤₚᵢ, or to the value of the lower signal-range limit X_{lowi}, if the parameter Xᵢ is smaller than the lower signal-range limit X_{lowi}.

Xᵢ=Xᵤₚᵢ for Xᵢ>Xᵤₚᵢ X_{lowi} for Xᵢ<X_{lowi} Xᵢ otherwise (1)

If a measured parameter Xᵢ comes to be disposed outside the permissible or defined signal range, the user is notified according to the method of the invention via the visualisation interface 80, for example, by marking the parameter Xᵢ in the colour red.

For each parameter Xᵢ, the next procedural stage S50 contains a calculation of the deviation ΔXᵢ of the entered and released parameter Xᵢ from its reference value X_{Refi} by forming the difference of the parameter Xᵢ from the associated reference value X_{Refi} according to equation (2). Since a positive deviation is required in order to allow a uniform mathematical treatment of each individual deviation, in procedural stage S50, a modulus formation is carried out in addition to the difference formation. Accordingly, negative differences, for example, the differences between the reference noise level and the measured noise level, or parameters with negative values, for example, negative signal levels, always lead to positive value deviations.

ΔXᵢ=|X_{Refi}−Xᵢ| (2)

Since the individual, entered and released parameters Xᵢ are dimension-bound values and are generally disposed in different ranges of orders of magnitude, a scaling of the individual deviations ΔXᵢ should be implemented in the following procedural stage S60 of the method according to the invention. The scaling guarantees that all determined deviations ΔXᵢ can be processed in a uniform manner in the subsequent procedural stages of the method according to the invention. The respective maximum-possible deviation ΔX_{iMax} is used as a reference value for scaling the deviations ΔXᵢ. This is obtained according to equation (3) from the maximum value of the deviation ΔXᵢ of the respective reference value X_{Refi} from the respective upper signal-range limit Xᵤₚᵢ or lower signal-range limit X_{lowi}. Positive values for the respective maximum-possible deviations ΔX_{iMax} in equation (3) are obtained in a similar manner to equation (2) by modulus-formation.

ΔX_{iMax}=|X_{Refi}−Xᵤₚᵢ| for |X_{Refi}−Xᵤₚᵢ|>|X_{Refi}−X_{lowi}∥X_{Refi}−X_{lowi}| for |X_{Refi}−X_{lowi}|>|X_{Refi}−Xᵤₚᵢ| (3)

Each deviation ΔXᵢ is scaled with the maximum-possible deviation ΔX_{iMax} determined respectively according to equation (3) by division formation. The scaled deviation Δ X̅ᵢ is then obtained according to equation (4):

$$Δ {\overline{X}}_{i} = \frac{\vert {X}_{Refi} - {X}_{i} \vert}{Δ {X}_{i MAX}} = \frac{Δ {X}_{i}}{Δ {X}_{i MAX}} \qquad ( 4 )$$

In the next procedural stage S70, the different significance, with regard to the quality Qₛ of a signal, of different magnitudes of deviations of a parameter Xᵢ relative to its respective reference value X_{Refi} is taken into consideration. For this purpose, the user is provided with a range of evaluation functions—for example, linear, quadratic, exponential and logarithmic evaluation.

In the case of a linear evaluation of the scaled deviation Δ X̅ᵢ, there is a linear correlation between the scaled deviation Δ X̅ᵢ and the quality Qₛ of the signal. The linear evaluation of the scaled deviation Δ X̅ᵢ within the framework of the calculation of the quality Qₛ of the signal is used, for example with the following parameters Xᵢ of the transmission signal:
Modulation error vector as an effective value in the logarithmic scale or a percentage (MER RMS dB or %)
Error vector as an effective value as a percentage (EVM RMS %)
Maximum modulation error as a percentage (MER MAX %)
Maximum error vector as a percentage (EVM %)
Number of packet errors/time unit
Number of segment errors/time unit
Upper shoulder distance in the logarithmic scale (in dB)
Lower shoulder distance in the logarithmic scale (in dB)
Ratio of modulation signal/carrier signal in dB
Amplitude asymmetry with IQ modulation
Quadrature error with IQ modulation
Residual carrier suppression in the logarithmic scale (in dB)
Signal to noise distance in the logarithmic scale (in dB)
Phase jitter (in dB)
Amplitude jitter (in dB)
Amplitude linearity (in dB)
Phase linearity (in °)
Group delay linearity
Signal level (in dB)
Carrier amplitude error in the logarithmic scale (in dB)
Crest factor
Power excess with complementary distribution function (CCDF).

In the ideal case of an agreement of the measured parameter Xᵢ with its reference value X_{Refi}, a value of 0 is obtained for the scaled deviation Δ X̅ᵢ according to equation (4), while in the worst-case of the maximum deviation ΔX_{iMax} of the measured parameter Xᵢ relative to its reference value X_{Refi}, the scaled deviation Δ X̅ᵢ according to equation (4) provides a value of 1. However, since a maximum deviation ΔX_{iMax} of parameter Xᵢ from its reference value X_{Refi} makes a minimum contribution Pᵢ of the parameter Xᵢ to the quality Qₛ of a signal, and an agreement of the measured parameter Xᵢ with its reference value X_{Refi} makes a maximum contribution Pᵢ of the parameter Xᵢ to the quality Qₛ of the signal, the contribution Pᵢ of a parameter Xᵢ to the quality Qₛ of the signal is calculated by complementation by means of subtraction of the scaled deviation Δ X̅ᵢ from the value 1 according to equation (5a) in the case of a linear evaluation of the scaled deviation Δ X̅ᵢ:

$${P}_{i} = 1 - \frac{\vert {X}_{Refi} - {X}_{i} \vert}{\vert Δ {X}_{i max} \vert} \qquad ( 5 a )$$

In the case of a quadratic evaluation of the scaled deviation Δ X̅ᵢ, a higher evaluation of larger, scaled modulus deviations Δ X̅ᵢ by comparison with smaller, scaled modulus deviations Δ X̅ᵢ is provided by means of the quadratic evaluation, because the former exert a significantly stronger negative influence on the quality Qₛ of the signal than the latter. The quadratic evaluation of the scaled deviation Δ X̅ᵢ in the calculation of the quality Qₛ of the signal is used, for example, with the following parameters:
Modulation frequency offset
Carrier frequency offset
Symbol rate offset
Bit rate offset

The contribution Pᵢ of a parameter Xᵢ to the quality Qₛ of the signal in the case of a quadratic evaluation of the scaled deviation Δ X̅ᵢ is calculated according to equation (5b):

$${P}_{i} = 1 - {( \frac{\vert {X}_{Refi} - {X}_{i} \vert}{\vert Δ {X}_{i max} \vert} )}^{2} \qquad ( 5 b )$$

A logarithmic evaluation of the scaled deviation Δ X̅ᵢ is used with parameters Xᵢ, in which the exponent is the significant value. The bit error rate (BER), which is calculated via the error function containing an exponential term, is a typical parameter Xᵢ for a logarithmic evaluation. Accordingly, a logarithmic evaluation is used, for example, with the following parameters Xᵢ:
Bit error rate before Viterbi
Bit error rate before Reed-Solomon
Bit error rate after Reed-Solomon

The contribution Pᵢ of a parameter Xᵢ to the quality Q_{S} of the signal in the case of a logarithmic evaluation is calculated according to equation (5c):

$$\begin{matrix}{P}_{i} = 1 - \frac{\vert log \frac{{X}_{Refi}}{{X}_{i}} \vert}{\vert log \frac{{X}_{Refi}}{{X}_{low i}} \vert} for \vert log \frac{{X}_{Refi}}{{X}_{low i}} \vert > \vert log \frac{{X}_{Refi}}{{X}_{up i}} \vert \\ = 1 - \frac{\vert log \frac{{X}_{Refi}}{{X}_{i}} \vert}{\vert log \frac{{X}_{Refi}}{{X}_{up i}} \vert} for \vert log \frac{{X}_{Refi}}{{X}_{up i}} \vert > \vert log \frac{{X}_{Refi}}{{X}_{low i}} \vert\end{matrix} \qquad ( 5 c )$$

An exponential evaluation of the scaled deviation Δ X̅ᵢ is used with parameters Xᵢ, in which the logarithm of the significant value is determined, for example, with signal levels, which are registered in a logarithmic scale in decibels and transformed by the exponential evaluation into the linear scale.

The contribution Pᵢ of a parameter Xᵢ to the quality Qₛ of the signal in the case of an exponential evaluation is calculated according to equation (5d):

$$\begin{matrix}{P}_{i} = 1 - \frac{\vert {e}^{{x}_{Refi}} - {e}^{{x}_{i}} \vert}{\vert {e}^{{x}_{Refi}} - {e}^{{x}_{low i}} \vert} for \vert {e}^{{x}_{Refi}} - {e}^{{x}_{low i}} \vert > \vert {e}^{{x}_{Refi}} - {e}^{{x}_{up i}} \vert \\ = 1 - \frac{\vert {e}^{{x}_{Refi}} - {e}^{{x}_{i}} \vert}{\vert {e}^{{x}_{Refi}} - {e}^{{x}_{up i}} \vert} for \vert {e}^{{x}_{Refi}} - {e}^{{x}_{up i}} \vert > \vert {e}^{{x}_{Refi}} - {e}^{{x}_{low i}} \vert\end{matrix} \qquad ( 5 d )$$

In the next procedural stage S80, a weighting factor Gᵢ for every contribution Pᵢ of the parameter Xᵢ is selected from a previously-established set of weighting factors Gᵢ. The user can select and if required modify this weighting factor Gᵢ via the visualisation interface 80 from the previously-established set of weighting factors Gᵢ. With the individual weighting factors Gᵢ, the respective contribution Pᵢ of the individual parameters Xᵢ is established in order to determine the quality Qₛ of the signal. For example, if several parameters Xᵢ, which are similar or related in terms of content, are used to determine the quality Qₛ of the signal, these are evaluated respectively with a lower weighting factor Gᵢ, in order to avoid overvaluing the aspect of the parameters Xᵢ, which are similar in content, by comparison with the aspects represented by the other parameters Xi.

The share Qᵢ achieved by a parameter Xᵢ through its contribution Pᵢ in the quality Qₛ of the signal can be calculated according to equation (6) by forming the products of the contributions Pᵢ of the individual parameters Xᵢ with the associated weighting factors Gᵢ:

$${Q}_{i} = \frac{{G}_{i} * {P}_{i}}{{\sum }_{i = 1}^{n} {G}_{i} * {P}_{i}} * 100 \% \qquad ( 6 )$$

Procedural stage S90 contains the calculation of the quality Qₛ of the signal. This is obtained according to equation (7) by weighting the contributions Pᵢ calculated in equations (5a), (5b), (5c) and (5d) of all of the total of n entered and released parameters Xᵢ with the respectively selected weighting factors Gᵢ and subsequent averaging.

$${Q}_{i} = \frac{{\sum }_{i = 1}^{n} {G}_{i} * {P}_{i}}{{\sum }_{i = 1}^{n} {G}_{i}} * 100 \% \qquad ( 7 )$$

The degree of fulfillment Eᵢ of a parameter Xᵢ is obtained according to equation (8a) for the linear evaluation, according to equation (8b) for the quadratic evaluation, according to equation (8c) for the logarithmic evaluation and according to equation (8d) for the exponential evaluation by multiplication of the equations (5a), (5b), (5c) and (5d) by 100%.

$$\begin{matrix}{E}_{i} = 1 - \frac{\vert {X}_{Refi} - {X}_{i} \vert}{\vert Δ {X}_{i Max} \vert} * 100 \% = {P}_{i} * 100 \% & ( 8 a ) \\ {E}_{i} = 1 - {( \frac{\vert {X}_{Refi} - {X}_{i} \vert}{\vert Δ {X}_{i Max} \vert} )}^{2} * 100 \% = {P}_{i} * 100 \% & ( 8 b ) \\ {E}_{i} = 1 - \frac{\vert log \frac{{X}_{Refi}}{{X}_{i}} \vert}{\vert log \frac{{X}_{Refi}}{{X}_{low i}} \vert} * 100 \% for \vert log \frac{{X}_{Refi}}{{X}_{low i}} \vert > \vert log \frac{{X}_{Refi}}{{X}_{up i}} \vert & ( 8 c ) \\ = 1 - \frac{\vert log \frac{{X}_{Refi}}{{X}_{i}} \vert}{\vert log \frac{{X}_{Refi}}{{X}_{up i}} \vert} * 100 \% for \vert log \frac{{X}_{Refi}}{{X}_{up i}} \vert > \vert log \frac{{X}_{Refi}}{{X}_{low i}} \vert & \\ {E}_{i} = 1 - \frac{\vert {e}^{{x}_{Refi}} - {e}^{{x}_{i}} \vert}{\vert {e}^{{x}_{Refi}} - {e}^{{x}_{low i}} \vert} * 100 \% for \vert {e}^{{x}_{Refi}} - {e}^{{x}_{low i}} \vert > \vert {e}^{{x}_{Refi}} - {e}^{{x}_{up i}} \vert \\ = 1 - \frac{\vert {e}^{{x}_{Refi}} - {e}^{{x}_{i}} \vert}{\vert {e}^{{x}_{Refi}} - {e}^{{x}_{up i}} \vert} * 100 \% for \vert {e}^{{x}_{Refi}} - {e}^{{x}_{up i}} \vert > \vert {e}^{{x}_{Refi}} - {e}^{{x}_{low i}} \vert & ( 8 d )\end{matrix}$$

In the final procedural stage S100, the results obtained are visualised graphically via the graphic-display device 70.

FIG. 3 provides a graphic representation of several parameters Xᵢ by way of example. The verbal marking and/or the abbreviation for the respective parameter Xᵢ is shown in the first column of the visualisation of FIG. 3. The second column of the visualisation shows the measurement value of the respective parameter Xᵢ as a numerical value with associated dimension, and, at the same time, a colour value is also shown, which corresponds to the degree of fulfillment Eᵢ of the measured parameter Xᵢ according to equations (8a) to (8b). The third column of the visualisation shows the degree of fulfillment Eᵢ of the measured parameter Xᵢ as a numerical percentage. At the same time, via the positioning of the arrow in the colour scale, the third column of the visualisation indicates the evaluation of the degree of fulfillment Eᵢ of the measured parameter Xᵢ relative to the poorest degree of fulfillment (poor) or the best degree of fulfillment (excellent). The fourth column of the visualisation contains the selected weighting factor (weight) Gᵢ of the parameter Xᵢ. Finally, the fifth column of the visualisation shows the respective contribution (number of points achieved: points) Pᵢ according to equations (5a) to (5b) and the share Qᵢ of the parameter Xᵢ in the quality Qₛ of the signal according to equation (6).

FIG. 4 contains the continuation of the graphic visualisation from FIG. 3. The drawing illustrates the selection options for graphic representations (EFA Graphics), for example, constellation diagram, eye monitoring, frequency spectrum, complementary distribution function (CCDF) etc. Warnings regarding signal-range overshoots of measured parameters Xᵢ are also presented. Finally, in the lower region of the graphic visualisation shown in FIG. 4, the quality value Qₛ of the transmission signal is specified as a percentage. The graphic visualisation in FIG. 4 also contains the number of measurements carried out (measurements), the total of all contributions Pᵢ actually made by the individual parameters Xᵢ to the quality Qₛ of the signal (sum result) and the maximum contributions Pᵢ attainable (points of total) of all parameters Xᵢ for the quality Qₛ of the signal.

The modified reference values X_{Refi} and weighting factors Gᵢ can be stored as so-called profiles for subsequent measurements. The individual measured parameters Xᵢ, the determined scaled and un-scaled deviations Δ X̅ᵢ and ΔXᵢ and the contributions Pᵢ made by the individual measured parameters Xᵢ to the quality Qₛ of the transmission signal can also be stored for subsequent purposes, for example, statistical evaluations, in the main computer 50.

The individual calculations of the method according to the invention for evaluating the quality of the signal can also optionally be stored. In this case, the individual, measured parameters Xᵢ of the transmission signal can be stored in the main computer 50 exclusively for protocol and archiving purposes.

The invention is not limited to the embodiments presented. In particular, the method according to the invention for evaluating the quality Qₛ of a signal can be extended to include not only communications signals but also all other signals, for example, control and regulation signals or other more complex measurement parameters, for example, in the field of medical diagnostics. With regard to digital radio signals, the method according to the invention is, of course, also suitable for digital audio radio signals, for example, according to the DAB (Digital Audio Broadcasting) standard, and for digital television broadcasting signals, not only according to the DVB-T standard, but also, for example, for VSB signals according to the American ATSC standard.

1. Method for evaluating the quality (Qₛ) of a signal on the basis of the deviation (ΔXᵢ) of at least one measured parameter (Xᵢ) of the signal relative to the associated reference value (X_{Refi}),
characterised in that
the quality (Qₛ) is calculated by averaging all of the determined and scaled deviations (Δ X̅ᵢ) relative to the respective parameters (Xᵢ).

2. Method for evaluating the quality of a signal according to claim 1,
characterised in that
the signal is a communications signal.

3. Method for evaluating the quality of a signal according to claim 1 or 2,
characterised in that
the deviations (Δ X̅ᵢ) determined for the respective parameters (Xᵢ) are weighted relative to one another.

4. Method for evaluating the quality of a signal according to any one of claims 1 to 3,
characterised in that
the deviation (ΔXᵢ) determined between the reference value (X_{Refi}) and the measured parameter (Xᵢ) is scaled by the maximum value of the deviation (ΔXᵢ) of the reference value (X_{Refi}) relative to an originally-established upper signal-range limit (Xᵤₚᵢ) and the deviation (ΔXᵢ) of the reference value (X_{Refi}) relative to an originally-established lower signal-range limit (X_{lowi}).

5. Method for evaluating the quality of a signal according to claim 4,
characterised in that
the deviation (ΔXᵢ) of the measured parameter (Xᵢ) relative to the reference value (X_{Refi}) is calculated by difference formation between the reference value (X_{Refi}) and the measured parameter (Xᵢ) and subsequent modulus formation.

6. Method for evaluating the quality of a signal according to claim 4 or 5,
characterised in that,
the deviation (ΔXᵢ) of the reference value (X_{Refi}) from the upper or lower signal-range limit (Xᵤₚᵢ, X_{lowi}) is calculated by difference formation between the reference value (X_{Refi}) and the upper or lower signal-range limit (Xᵤₚᵢ, X_{lowi}) and subsequent modulus formation.

7. Method for evaluating the quality of a signal according to any one of claims 4 to 6,
characterised in that
the measured parameter (Xᵢ) is set to an originally-established upper or respectively lower signal-range limit (Xᵤₚᵢ, X_{lowi}), if the measured parameter (Xᵢ) is respectively greater or smaller than the respective upper or lower signal-range limit (Xᵤₚᵢ, X_{lowi}).

8. Method for evaluating the quality of a signal according to any one of claims 4 to 7,
characterized in that
the scaled deviations (Δ X̅ᵢ) are evaluated in a linear or quadratic manner.

9. Method for evaluating the quality of a signal according to any one of claims 4 to 7,
characterized in that
the reference values (X_{Refi}) and the parameters (Xᵢ) are evaluated in a logarithmic or exponential manner.

10. Method for evaluating the quality of a signal according to any one of claims 1 to 9,
characterized in that
the calculated value of the quality (Qₛ) and/or the determined and scaled deviations (Δ X̅ᵢ) relative to the respective parameters (Xᵢ) are visualised.

11. Method for evaluating the quality of a signal according to claim 10,
characterized in that
the calculated value of the quality (Qₛ) and/or the determined and scaled deviations (Δ X̅ᵢ) relative to the respective parameters (Xᵢ) are visualised with a colour scale.

12. Computer program with program code means for the implementation of all of the stages according to any one of claims 1 to 10, when the program is executed on a computer or a digital signal processor.

13. Computer program with program code means for the implementation of all the stages according to any one of claims 1 to 10, when the program is stored on a machine-readable data medium.

14. Machine-readable data medium with stored program code means for the implementation of all of the stages according to any one of claims 1 to 11, when the program is executed on a computer or a digital signal processor.

15. Device for evaluating the quality (Qₛ) of a signal according to any one of claims 1 to 11 consisting of at least one test measurement receiver (10) for registering the signal and a main computer (50) for determining the quality (Qₛ) of the signal.

16. Device for evaluating the quality (Qₛ) of a signal according to claim 15,
characterised in that
several test and measurement receivers (10-40) are set up at different positions in the network of the signal to be transmitted.

17. Device for evaluating the quality (Qₛ) of a signal according to claim 15 or 16,
characterised in that
the individual test measurement receivers (10; 10-40) are connected to the main computer (50) via standard data transmission ports for the implementation of a remote inquiry.

18. Device according to any one of claims 15 to 17,
characterized in that
the main computer (50) is connected to a graphic-display device (70) for the graphic visualisation of the results.

| | |
|---|---|
| | Start |
| S10 | Entry of the individual parameters |
| S20 | Optional release of the individual parameters |
| S30 | Selection of a reference value for each |
| | released parameter from a set of reference |
| | values |
| S40 | If the measured parameter is disposed outside |
| | the established signal range, measurement of |
| | the measured parameter at the signal-range |
| | limit |
| S50 | Calculation of the deviation relative to the |
| | reference value for every measured parameter |
| S60 | Scaling all of the deviations |
| S70 | Parameter-typical evaluation of every scaled |
| | deviation |
| S80 | Selection of a weighting factor for every |
| | scaled deviation |
| S90 | Calculation of the signal quality by weighted |
| | averaging of the deviations |
| S100 | Verbal and graphic visualisation of the |
| | individual results and aggregated results |
| | End |
